(19) United States
(12) Patent Application Publication
(10) Pub. No.: US 2018/0066154 A1
(43) Pub. Date: Mar. 8, 2018

(54) Screen Restoration Composition

(71) Applicants: Raymond Stallworth, Mulberry, FL (US); Michael Stallworth, Mulberry, FL (US); Fred Howerton, Lakeland, FL (US)

(72) Inventors: Raymond Stallworth, Mulberry, FL (US); Michael Stallworth, Mulberry, FL (US); Fred Howerton, Lakeland, FL (US)

(21) Appl. No.: 15/695,534

(22) Filed: Sep. 5, 2017

Related U.S. Application Data
(60) Provisional application No. 62/382,873, filed on Sep. 2, 2016.

(51) Int. Cl. C09D 133/20; C09D 4/00; C09D 133/08; C08F 20/68

(52) U.S. Cl. CPC C09D 133/20; C08F 20/68; C09D 133/08; C09D 4/00

(57) ABSTRACT

A composition for cleaning and restoring screens. The composition includes water, acrylic polymer, trimethylpentanediol isobutrate, barium sulfate, and carbon black. The composition restores the dark color of screens that have faded due to weathering and protects the screen from future deterioration.

### CROSS REFERENCE TO RELATED APPLICATIONS

This application claims the benefit of U.S. Provisional Application No. 62/382,873 filed on Sep. 2, 2016. The above identified patent application is herein incorporated by reference in its entirety to provide continuity of disclosure.

### BACKGROUND OF THE INVENTION

The present invention relates to a composition for restoring and cleaning screens. Specifically, the present invention provides a composition that restores the black color of window or door screens that have been faded over time.

Over time, a screen exposed to the harsh weather conditions of the outdoors will become dirty, faded and chipped, losing its luster. A home with dirty or faded screens may depreciate in value due to the loss of curb-side aesthetic appeal. To repair faded or damaged screens, most homeowners have to buy new screens to replace the old, damaged or faded screen. Therefore, to address these concerns, the present invention provides a composition for a screen restoration solution that restores the original black color of the screen and impedes further damage thereto.

### SUMMARY OF THE INVENTION

In view of the foregoing disadvantages inherent in the known types of now present in the known art, the present invention provides a composition for restoring screens wherein the same can be utilized for providing convenience for the user when maintaining the aesthetic appeal and value of a home. The present system includes water an acrylic polymer, trimethylpentanediol isobutrate, barium sulfate and carbon black.

One object of the present invention is to provide a composition that possess properties which allows a user to restore weathered screens by applying a coat of the composition to the screen, containing, a quantity of distilled water, a quantity of an acrylic polymer, a quantity of trimethylpentanediol isobutrate, a quantity of barium sulfate and a quantity of carbon black.

Another object of the present invention is to provide a composition that utilizes acrylic ester acrylonitrile copolymer as a coating agent.

### DETAILED DESCRIPTION OF THE INVENTION

The objects of the present invention are achieved by a liquid composition described herein. Unless specifically limited to a single unit, “a” is intended to be equivalent to “one or more” throughout the present disclosure. Additionally, unless specifically limited to a specific type, “wire mesh” includes both metal wire mesh and fiberglass wire mesh.

The screen restoring composition comprises a quantity of distilled water about equal to 45 to 63.8 percent volume, a quantity of an acrylic polymer about equal to 18.8 to 37.5 percent volume, a quantity of trimethylpentanediol isobutrate equal to 9 percent volume, a quantity of barium sulfate about equal to 4 percent volume and a quantity of carbon black about equal to 4 percent volume.

The combination of distilled water, acrylic polymer, and trimethylpentanediol isobutyrate in the ratio described above creates an ideal liquid composition for coating a screen. The resulting liquid composition of this combination is a semi-viscous fluid that can adhere to the wire mesh of a screen while leaving the gaps in the screen unblocked.

The acrylic polymer present in the screen restoring composition is a binding agent that can bind to the wire mesh of a screen. Once bound to the wire mesh of a screen, the acrylic polymer coating adds forms a protective layer on the wire mesh, essentially sealing the wire mesh from weathering elements. In one embodiment, the acrylic polymer is composed of an acrylic ester acrylonitrile copolymer. However, the monomer of the acrylic polymer can be any other acrylic monomer, or combination of monomers, synthesized from an acrylic acid and an alcohol.

Carbon black also operates as an additional binding agent, and color additive, in the screen restoring composition. Carbon black is essentially pure elemental carbon created by incomplete combustion or thermal decomposition of gaseous or liquid hydrocarbons. Carbon black is a chemisorption molecule. In this way, the Carbon black in the screen restoring compound binds to both the acrylic polymer present in the screen restoring composition and a surface of a substrate, in this instance, the wire mesh of the screen. Carbon black also provides pigmentation to the screen restoring compound, dying the screen restoring compound a black color, resembling that of a typical screen mesh. In other embodiments, carbon black may be substituted or complimented with other pigmentation additives to provide a screen restoring composition in a color other than black.

The ratio of the quantity of distilled water to the quantity of acrylic polymer varies depending on the wire mesh size of a screen to which the screen restoration compound will be applied. The denser the wire mesh of the screen, the higher the ratio is between the quantity of distilled water and the quantity of the acrylic polymer. For example, embodiments of the screen restoration composition adapted for a 14×18 screen size utilize a ratio of 45 percent volume of distilled water to 37.5 percent volume of acrylic polymer; whereas, embodiments of the screen restoration composition adapted for a 20×20 screen size utilize a ratio of 63.8 percent volume of distilled water to 18.8 percent volume of acrylic polymer.

The screen restoration composition excludes any element, step, or ingredient not specified in the claims except those that do not materially affect the basic and novel characteristics of the claimed invention. Here, the novel characteristics of the screen restoration compound derive from the combination of reagents consisting essentially of 45 to 63.8 percent volume of water, 18.8 to 37.5 percent volume of an acrylic polymer, 9 percent volume of trimethylpentanediol isobutyrate, 4 percent volume of barium sulfate, and 4 percent volume of carbon black. As stated above, this combination results in a grey-black, semi-viscous fluid that can adhere to the wire mesh of a screen while leaving the gaps in the screen unblocked, successfully restoring chipped and faded screens.

To apply the screen restoration composition to a screen, an applicator should first shake and stir the screen restoration composition thoroughly before application. Next, the applicator should clean the screen to remove latent dirt and debris from the screen. Using a nap roller, brush or sponge, the applicator can apply the screen restoration composition to a side of the screen. Only one coat of the screen restoration composition per side of the screen is necessary. To ensure even application, the applicator should back roll or brush the screen restoration composition applied to the screen.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A screen restoration composition, comprising:
water;
an acrylic polymer;
trimethylpentanediol isobutyrate;
barium sulfate;
carbon black.

2) The screen restoration composition of claim 1, wherein the water comprises 45 to 63.8 percent volume of the screen restoration composition.

3) The screen restoration composition of claim 2, wherein the acrylic polymer comprises 18.8 to 37.5 percent volume of the screen restoration composition.

4) The screen restoration composition of claim 3, wherein the trimethylpentanediol isobutyrate comprises about 9 percent volume of the screen restoration composition.

5) The screen restoration composition of claim 4, wherein the barium sulfate comprises about 9 percent volume of the screen restoration composition.

6) The screen restoration composition of claim 5, wherein the carbon black comprises about 4 percent volume of the screen restoration composition.

7) The screen restoration composition of claim 1, wherein the acrylic polymer is an acrylic ester acrylonitrile copolymer.

8) A screen restoration composition consisting essentially of 45 to 63.8 percent volume of water, 18.8 to 37.5 percent volume of an acrylic polymer, 9 percent volume of trimethylpentanediol isobutyrate, 4 percent volume of barium sulfate, and 4 percent volume of carbon black.

9) The screen restoration composition of claim 8, wherein the acrylic polymer is an acrylic ester acrylonitrile copolymer.
